(19) United States
(12) Patent Application Publication
(10) Pub. No.: US 2022/0032431 A1
(43) Pub. Date: Feb. 3, 2022

(54) Steering Wheel Cover Manipulating Device

(71) Applicant: Broderick Kyle, Cartersville, VA (US)

(72) Inventor: Broderick Kyle, Cartersville, VA (US)

(21) Appl. No.: 16/942,924

(22) Filed: Jul. 30, 2020

(51) Int. Cl. B25B 27/00; B25G 1/10

(52) U.S. Cl. CPC B25B 27/0035; B62D 1/06; B25G 1/102

(57) ABSTRACT

A steering wheel cover manipulating device for installing and removing a steering wheel cover includes a bar, which is flat. The bar is arcuate proximate to a first end thereof defining a linear section of the bar and a tool head. The tool head is substantially semicircularly shaped when viewed from a respective opposed side of the bar. The tool head is substantially complementary to a cross-sectional segment of a steering wheel. The linear section can be grasped in a hand of a user so that the user is positioned to position the tool head between a steering wheel cover and the steering wheel. The tool head can be slid along an interface of the steering wheel cover and the steering wheel to facilitate installation and removal of the steering wheel cover.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to manipulating devices and more particularly pertains to a new manipulating device for installing and removing a steering wheel cover.

### (2) Description of Related Art including Information Disclosed Under 37 CFR 1.97 and 1.98.

The prior art relates to manipulating devices. The prior art teaches pry bars with handles but does not teach the base features of the present invention.

### BRIEF SUMMARY OF THE INVENTION

An embodiment of the disclosure meets the needs presented above by generally comprising a bar, which is flat. The bar is arcuate proximate to a first end thereof defining a linear section of the bar and a tool head. The tool head is substantially semicircularly shaped when viewed from a respective opposed side of the bar. The tool head is substantially complementary to a cross-sectional segment of a steering wheel. The linear section is configured to be grasped in a hand of a user so that the user is positioned to position the tool head between a steering wheel cover and the steering wheel. The tool head is configured to be slid along an interface of the steering wheel cover and the steering wheel to facilitate installation and removal of the steering wheel cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a steering wheel cover manipulating device according to an embodiment of the disclosure.

FIG. 2 is a bottom isometric perspective view of an embodiment of the disclosure.

FIG. 3 is a side view of an embodiment of the disclosure.

FIG. 4 is a bottom view of an embodiment of the disclosure.

FIG. 5 is an in-use view of an embodiment of the disclosure.

### DETAILED DESCRIPTION OF THE INVENTION

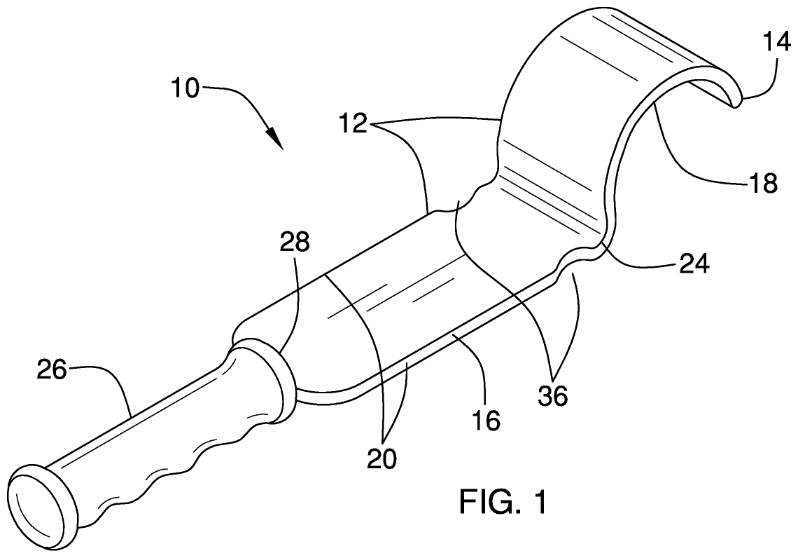

With reference now to the drawings, and in particular to FIGS. 1 through 5 thereof, a new manipulating device embodying the principles and concepts of an embodiment of the disclosure and generally designated by the reference numeral 10 will be described.

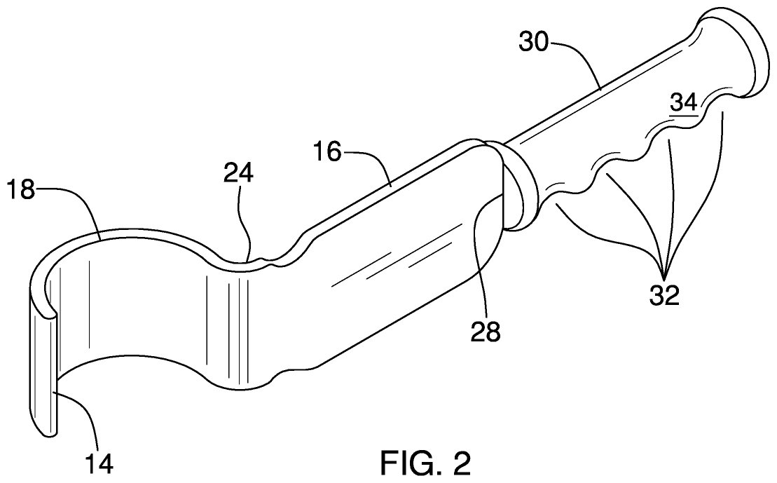

As best illustrated in FIGS. 1 through 5, the steering wheel cover manipulating device 10 generally comprises a bar 12, which is flat, as shown in FIGS. 1 and 2. The bar 12 is arcuate proximate to a first end 14 thereof defining a linear section 16 of the bar 12 and a tool head 18. The tool head 18 is substantially semicircularly shaped when viewed from a respective opposed side 20 of the bar 12 so that the tool head 18 is substantially complementary to a cross-sectional segment of a steering wheel.

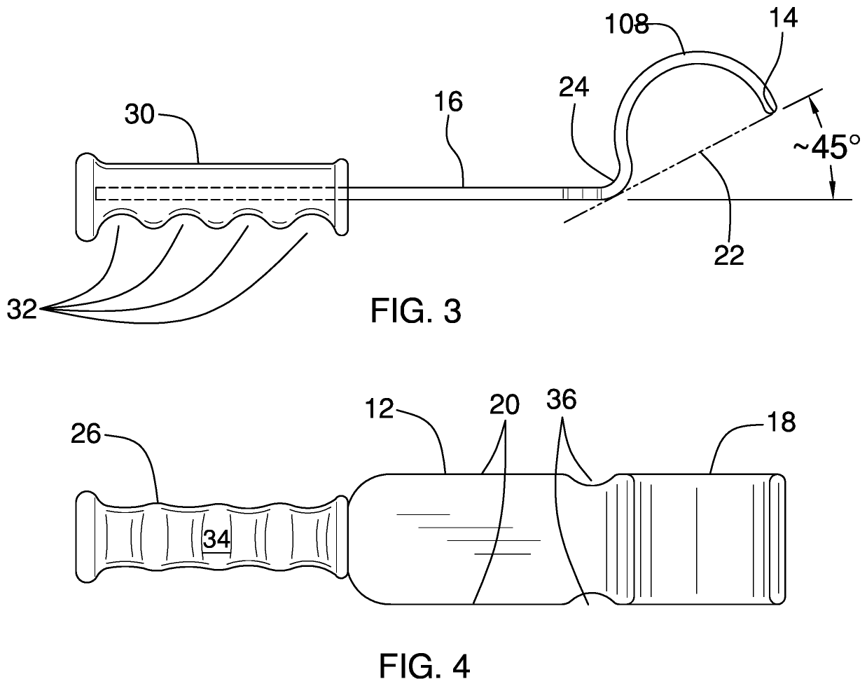

An imaginary line 22 extends between the first end 14 and a junction 24 of the linear section 16 and the tool head 18. The imaginary line 22 is transverse to the linear section 16, as shown in FIG. 3. As will become apparent, the tool head 18 being offset from the linear section 16 facilitates positioning of the device 10 in an operable position relative to a steering wheel cover and the steering wheel. The imaginary line 22 may be at forty five degrees to the linear section 16.

The linear section 16 is configured to be grasped in a hand of a user so that the user is positioned to position the tool head 18 between the steering wheel cover and the steering wheel. The tool head 18 is configured to be slid along an interface of the steering wheel cover and the steering wheel to facilitate installation and removal of the steering wheel cover.

A handle 26 is engaged to and extends from a second end 28 of the bar 12. The handle 26 is configured to be grasped in the hand of the user so that the user is positioned to manipulate the steering wheel cover. As shown in FIGS. 3 and 4, the handle 26 comprises a rod 30, which extends colinearly with the linear section 16 of the bar 12. Each of a plurality of indentations 32 extends arcuately into a lower face 34 of the rod 30. The indentations 32 are configured to position digits of the hand of the user to enhance a grasp upon the handle 26.

The bar 12 has a pair of cutouts 36 extending thereinto. Each cutout 36 extends arcuately into a respective opposed side 20 of the bar 12 within the linear section 16 and proximate to the tool head 18. The cutouts 36 are configured to engage a lip of the steering wheel cover when the tool head 18 is positioned between the steering wheel cover and the steering wheel.

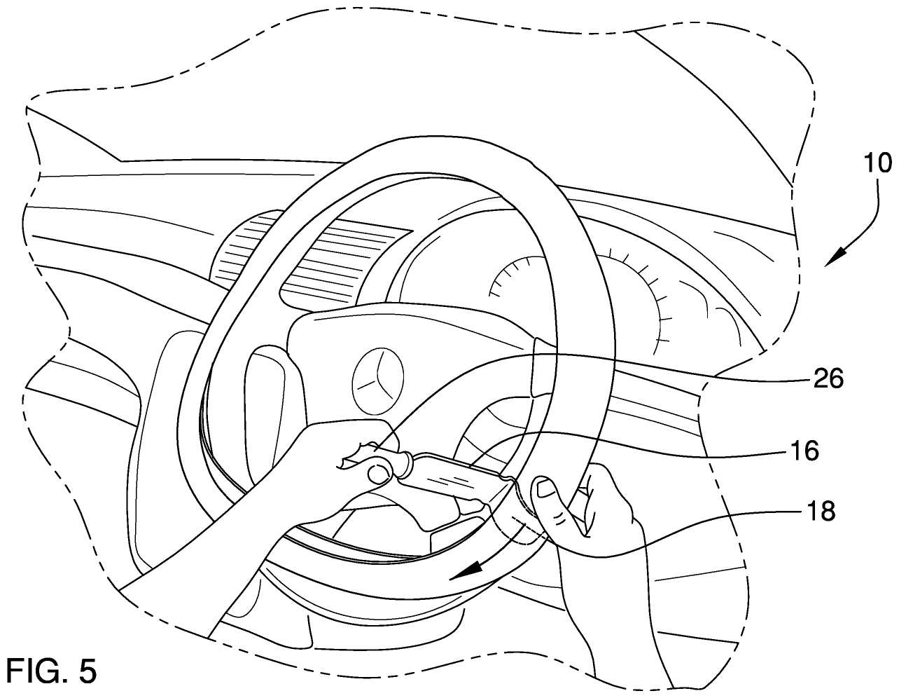

In use, a steering wheel cover is partially positioned over the steering wheel. New steering wheel covers fit very tightly, and it is difficult to fully position the steering wheel cover over the steering wheel. The handle 26 is grasped in the hand of the user and the tool head 18 is positioned between the steering wheel cover and the steering wheel, as shown in FIG. 5. The user then is positioned to place a hand on the steering wheel cover and over the tool head 18. Moving the hand and the tool head 18 simultaneously around the steering wheel then completes the installation. If necessary, the handle 26 and linear section 16 can be pivoted relative to the steering wheel to apply a stretching force to the steering wheel cover.

Similarly, the device 10 can be utilized to remove a tight fitting steering wheel cover. In this situation, the tool head 18 is inserted between the steering wheel cover and the steering wheel while maintaining the handle 26 and the linear section 16 outside a circumference of the steering wheel. The handle 26 and linear section 16 can be pivoted relative to the steering wheel to stretch the steering wheel cover so that is can be slid off of the steering wheel.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A steering wheel cover manipulating device comprising a bar, the bar being flat, the bar being arcuate proximate to a first end thereof defining a linear section of the bar and a tool head, the tool head being substantially semicircularly shaped when viewed from a respective opposed side of the bar, such that the tool head is substantially complementary to a cross-sectional segment of a steering wheel, wherein the linear section is configured for grasping in a hand of a user, positioning the user for positioning the tool head between a steering wheel cover and the steering wheel, wherein the tool head is configured for sliding along an interface of the steering wheel cover and the steering wheel for facilitating installation and removal of the steering wheel cover.

2. The steering wheel cover manipulating device of claim 1, further including an imaginary line extending between the first end and a junction of the linear section and the tool head, the imaginary line being transverse to the linear section.

3. The steering wheel cover manipulating device of claim 2, wherein the imaginary line is at forty five degrees to the linear section

4. The steering wheel cover manipulating device of claim 1, further including a handle engaged to and extending from a second end of the bar, wherein the handle is configured for grasping in the hand of the user, positioning the user for manipulating the steering wheel cover

5. The steering wheel cover manipulating device of claim 4, wherein the handle comprises a rod, each of a plurality of indentations extends arcuately into a lower face of the rod, wherein the indentations are configured for positioning digits of the hand of the user for enhancing a grasp upon the handle.

6. The steering wheel cover manipulating device of claim 5, wherein the rod extends colinearly with the linear section of the bar.

7. The steering wheel cover manipulating device of claim 1, further including the bar having a pair of cutouts extending thereinto, each cutout extending arcuately into a respective opposed side of the bar within the linear section and proximate to the tool head, wherein the cutouts are configured for engaging a lip of the steering wheel cover when the tool head is positioned between the steering wheel cover and the steering wheel.

8. A steering wheel cover manipulating device comprising:
a bar, the bar being flat, the bar being arcuate proximate to a first end thereof defining a linear section of the bar and a tool head, the tool head being substantially semicircularly shaped when viewed from a respective opposed side of the bar, such that the tool head is substantially complementary to a cross-sectional segment of a steering wheel, wherein the linear section is configured for grasping in a hand of a user, positioning the user for positioning the tool head between a steering wheel cover and the steering wheel, wherein the tool head is configured for sliding along an interface of the steering wheel cover and the steering wheel for facilitating installation and removal of the steering wheel cover, an imaginary line extends between the first end and a junction of the linear section and the tool head, the imaginary line being transverse to the linear section, the imaginary line being at forty five degrees to the linear section;
a handle engaged to and extending from a second end of the bar, wherein the handle is configured for grasping in the hand of the user, positioning the user for manipulating the steering wheel cover, the handle comprising a rod, each of a plurality of indentations extends arcuately into a lower face of the rod, wherein the indentations are configured for positioning digits of the hand of the user for enhancing a grasp upon the handle, the rod extending colinearly with the linear section of the bar; and
the bar having a pair of cutouts extending thereinto, each cutout extending arcuately into a respective opposed side of the bar within the linear section and proximate to the tool head, wherein the cutouts are configured for engaging a lip of the steering wheel cover when the tool head is positioned between the steering wheel cover and the steering wheel.
